(19) United States
(12) Patent Application Publication
(10) Pub. No.: US 2021/0284470 A1
(43) Pub. Date: Sep. 16, 2021

(54) BAGGAGE AND PARCEL HANDLING SYSTEM AND METHOD

(71) Applicant: Leidos Security & Automation Limited, Kempston (GB)

(72) Inventors: Richard Cottle, Birmingham (GB); Luke Thomas Woods, Cheshire (GB); William Edward Watt, Bedfordshire (GB); Brian Swanson, Grand Blanc, MI (US); Velibor Kilibarda, Southfield, MI (US); Kenneth Hamel, Bloomfield Hills, MI (US); Freddie Tappo, Sterling Heights, MI (US); William Frazer, Wixom, MI (US); Bryan Finzel, Macomb Township, MI (US); Martin Kinsella, Bloomfield, MI (US)

(21) Appl. No.: 17/200,577

(22) Filed: Mar. 12, 2021

Related U.S. Application Data
(60) Provisional application No. 62/988,574, filed on Mar. 12, 2020.

(51) Int. Cl. B65G 67/32

(52) U.S. Cl. CPC B65G 67/32; B65G 2201/0264

(57) ABSTRACT

Described herein are systems and methods for baggage or parcel handling. The system includes an automated bag unloading cell, a container roller deck positioned in the automated unloading cell. The container roller deck includes a roller deck base and a deck frame. The deck frame can selectively support and transfer a container housing a bag or parcel. The deck frame can selectively rotate about a deck frame axis of rotation relative to the roller deck base. The deck frame is operable to selectively release the bag or parcel from the container. The container roller deck can also include an index table in communication with the deck frame. The index table can be operable to receive the bag or parcel released from the container. The index table can include at least one index table conveyor operable to selectively advance the bag or parcel from the index table to a first transfer device.

### CROSS-REFERENCE TO RELATED PATENT APPLICATIONS

This application claims priority to U.S. Provisional Application No. 62/988,574, filed on Mar. 12, 2020, the entire content of which is hereby incorporated by reference in its entirety.

### BACKGROUND

In today's global and fast-moving economies the handling of parcels and baggage associated with passenger mass transit, and in particular air travel, continues to rely in large part on a person to sort, stack, load and unload parcels and baggage.

Passenger checked bags returning to and re-entering an airport terminal are often housed in containers, commonly called unit load devices (ULDs) which, depending on the size of the airplane, may travel with the plane and be unloaded as a single unit. In smaller airplanes, the bags may enter the plane individually with the assistance of a ground level, mobile belt conveyor. In these instances, the bags are often removed from the plane through a similar mobile, belt conveyor into ULDs or other containers for travel into the airport terminal.

Conventional luggage arrival systems include manually intensive operations where human operators must remove each bag from the container and place the bag on a conveyor, or multiple conveyors, which is physically demanding and time consuming. Automating these bag unloading operations has proven difficult. This is due to many reasons, including the almost unlimited differences in the sizes, shapes, rigidity, volumes, and weights of passenger bags. For example, the high variation in the physical characteristics of passenger bags has made it very difficult to automate, for example using programmable robots, the physical loading and unloading of all bags into the baggage containers or delivery carts for transport from the airplane gate and inside the airport terminal for processing and delivery to passengers.

There is a need for devices and methods that would solve or improve on these difficulties and disadvantages in unloading and handling passenger checked bags on arrival into an airport, or other facility, for processing and delivery to passengers. These improvements are also applicable in other applications, for example airport baggage sortation systems used for connecting flights.

### SUMMARY

Disclosed herein is a baggage or parcel handling system having particular usefulness and efficiency at airports where thousands of passengers and checked bags an hour are processed. It is understood that what is taught herein is useful in other applications, for example, airport baggage transfer areas, passenger rail or cruise arrival centers, as well as packages and cargo shipping and distribution facilities.

In one exemplary embodiment, a handling system and method of operation includes an airport terminal bag arrival area which includes bag arrival and transfer areas. In one example of use in a terminal bag arrival area, the terminal bag arrival area includes at least one automated bag unloading cell and a manual or semi-automated unloading cell in communication with the automated unloading cell.

In some embodiments of an automated unloading cell, baggage delivery carts are connected together to form “trains” of single-file delivery carts pulled by transfer vehicles, commonly called tuggers. The delivery carts each carry one or more onboard containers, for example unit load devices (ULDs) or other baggage containers, filled with checked passenger bags recently unloaded from an arriving airplane.

In some exemplary embodiments, each delivery cart is sequentially aligned with a container roller deck positioned in the automated unloading station. On verification of proper alignment between the delivery cart and the container roller deck, the filled container is automatically transferred from the delivery cart to a deck frame. In one embodiment, a powered roller platform is used to engage the container and transfer it to the deck frame without human intervention (no physical lifting and transferring of bags in the automated unloading station).

In some exemplary embodiments, the container roller deck rotates the deck frame from a first position to a second position, approximately 65-70 degrees, thereby urging the bags by gravitational force from the container toward, and partially onto, an index table connected to the deck frame. The index table is then rotated down relative to the deck frame until the index table is approximately horizontal. In some exemplary embodiments, at least a number of the bags positioned on the index table are transferred from the container toward a first transfer device conveyor in a manner described below.

In response to an event or time, the deck frame is then rotated from the first position by approximately 20-30 degrees toward the second position, to further urge the remaining bags onto the index table. Thereafter, the deck frame can be rotated back to its original or first position where the empty container can be transferred to a delivery cart and a new container filled with bags can be loaded into the deck frame for unloading. In some exemplary embodiments, the index table includes a plurality of, individually advanceable lateral belt conveyors to selectively move the supported bags toward and onto a first delivery transfer device, for example a first transfer belt conveyor in direct communication with bag carousels where passengers reacquire their bags.

In some exemplary embodiments of the index table, at least two belt conveyors are activated to advance each bag supported by that particular belt conveyor onto the transfer belt conveyor. This advantageously, at least in part, serves to sequence, each bag at a desired distance from one another on the transfer conveyor belt to aid further processing, for example bag security or re-entry screening.

In some exemplary embodiments, one or more singulation conveyor belts are positioned along the first transfer belt conveyor so as to further assist in sequencing and positioning the bags to a desired distance from one another as described above.

In some exemplary embodiments, a manual or semi-automated unloading cell is used in communication with the automated unloading cell described above. In the example manual unloading cell, human operators are used to manually unload the containers which contain, for example, bags or cargo that are not suitable for automated unloading in the automated unloading station. The manual unloading cell further serves as a back-up in the event a malfunction, maintenance or other condition prevents use of the automated unloading station. Bags processed through the manual unloading station are placed on a second transfer device, for example, a second transfer belt conveyor that is in communication with the first transfer device described above. The manual unloading cell may also include one or more forms of automation, for example robotic or other programmable devices to provide semi-automated operations.

In some exemplary embodiments, a screening device is positioned in communication with the first and second transfer devices to selectively provide the necessary security, or customs screening or both, of the bags depending on one or more factors, for example if the bags arrived from an international flight or other point of origin of interest or elevated risk.

In some exemplary embodiments, a carousel diverter device is used to automatically divert or route selected bags toward a selected carousel feeder conveyor. Each feeder conveyor is in communication with a single baggage carousel for transport of the selectively diverted bags to their final destination at a desired bag carousel, for example designated for a particular arriving flight.

### BRIEF DESCRIPTION OF THE DRAWINGS

The skilled artisan will understand that the drawings are primarily for illustrative purposes and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar or structurally similar elements).

The foregoing and other features and advantages provided by the present disclosure will be more fully understood from the following description of exemplary embodiments when read together with the accompanying drawings, in which:

FIG. 1 is a perspective view of an exemplary baggage arrival handling system in an exemplary airport;

FIG. 2 is an enlarged perspective view of a portion of FIG. 1;

FIG. 3 is a perspective view of an exemplary automated unloading cell including an exemplary container roller deck and exemplary index table in a second position and without a roller platform;

FIG. 3A is another perspective view of exemplary automated unloading cell with an exemplary roller platform;

FIG. 4 is an exemplary exploded perspective view of a container roller deck as taught herein;

FIG. 5 is a perspective view of an exemplary container roller deck illustrating a roller deck frame in a first position supporting two containers and an index table in a first position;

FIG. 6A is a side view of an exemplary container roller deck illustrating a roller deck frame in a second position and an index table in a first position;

FIG. 6B is another side view of an exemplary container roller deck illustrating a deck frame in a second position and an index table in a second position;

FIG. 6C is an another side view of an exemplary container roller illustrating a deck frame in a first position and an index table rotating back to the first position;

FIG. 7 is a block diagram of an exemplary control system for an exemplary baggage and parcel handling system and method of operation as taught herein; and

FIG. 8 is an exemplary flow chart illustrating steps for an exemplary method for unloading bags as taught herein.

### DETAILED DESCRIPTION

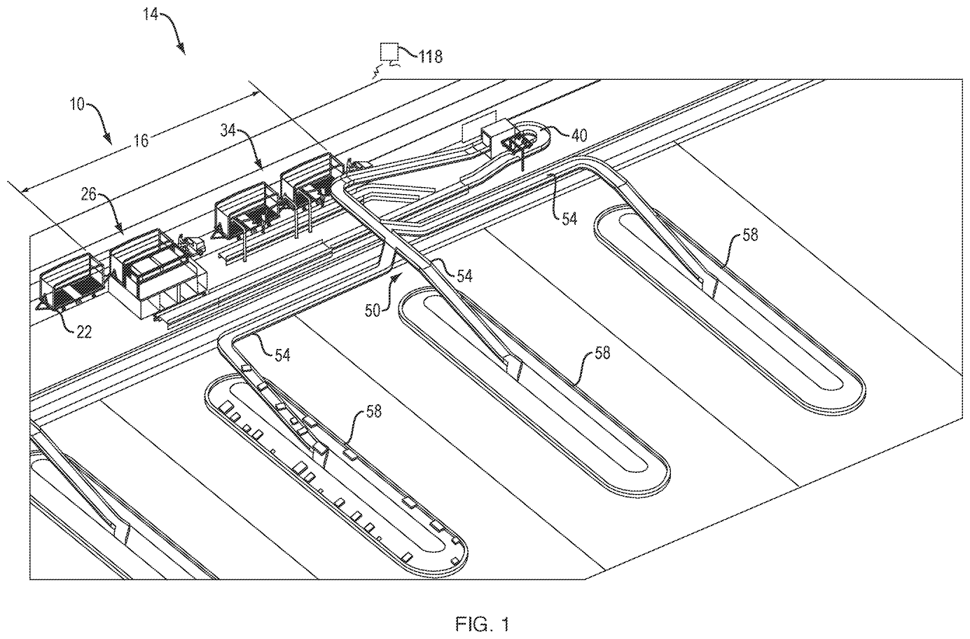

Referring to FIGS. 1-8 examples of a baggage and parcel handling system and methods are described. In some embodiments, the system and methods taught herein are advantageous in a high-volume quantity, mass transit passenger airport baggage arrival area where passenger checked bags are unloaded from airplanes and routed to passenger carousels for pick-up. In some embodiments, the system and methods taught herein are advantageous in a high-volume quantity parcel and package environment. In some embodiments, the system and methods taught herein are advantageous in outbound baggage sortation systems for handling passenger bags for connecting flights. In some embodiments, the system and methods taught herein are advantageous in mass transit or large municipal trains, busses, and sea travel facilities. In some embodiments, the system and methods taught herein are advantageous in container or other cargo receipt, handling and/or distribution centers.

As used herein, the terms bag, bags, baggage or luggage refer to received passenger bags or luggage, as well to other parcels, packages, containers, boxes, and other structures which are received at a commercial facility, for example an airport.

To facilitate description of the systems and methods disclosed herein, an airport environment using passenger bags is used. Nonetheless, the systems and methods disclosed herein are equally applicable to other logistic operations that may handle and move large volumes of packages or parcels.

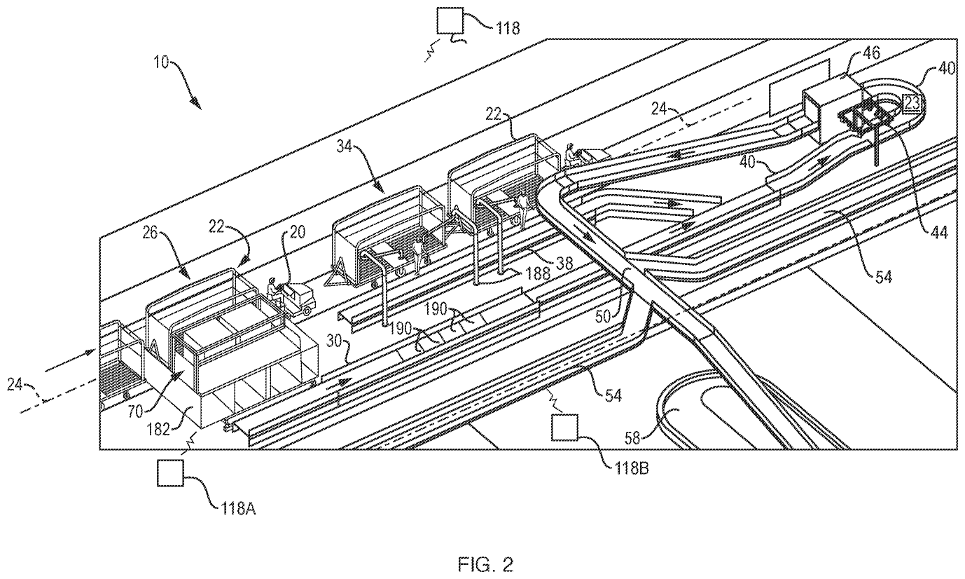

Referring to FIGS. 1 and 2, an exemplary baggage and parcel arrival handling system 10 is shown, for example, in a mass transit or large municipal airport 14. System 10 includes a terminal baggage arrival area 16 where transfer vehicles (commonly called tuggers) 20 transfer one or more delivery carts 22 each carrying one container 18 housing a plurality of passenger bags 23 along a path of travel 24 as further described below.

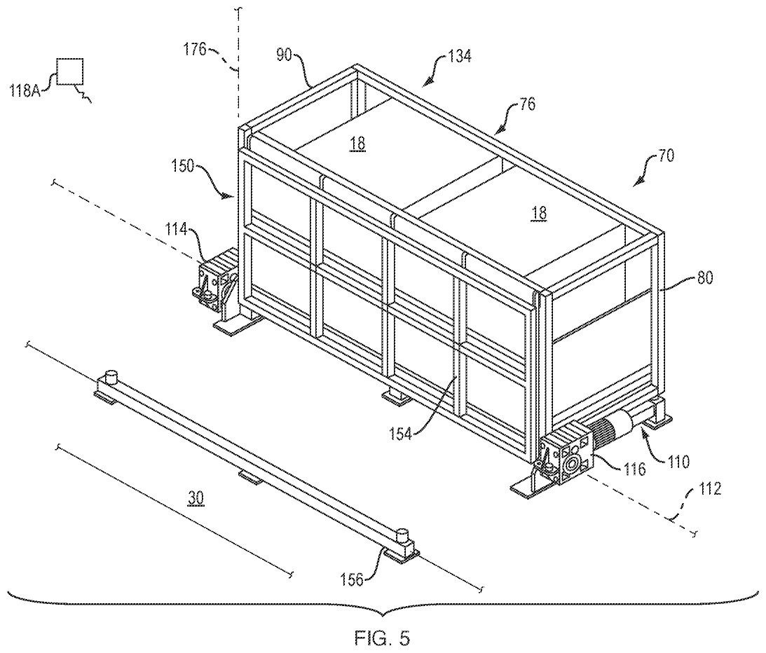

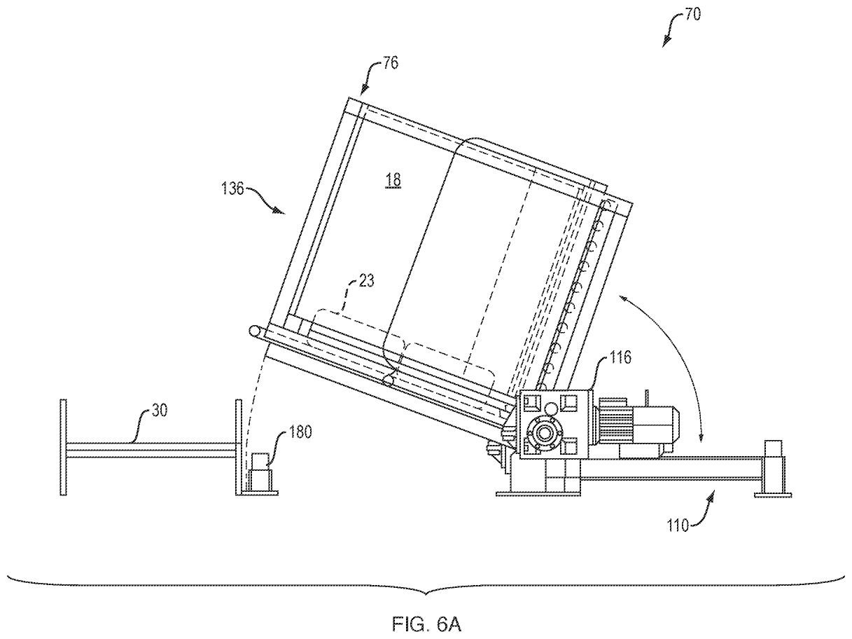

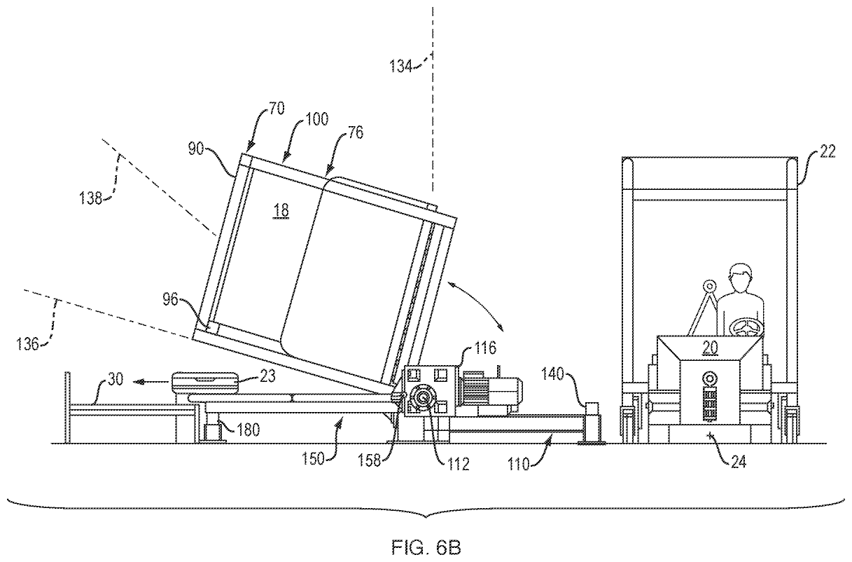

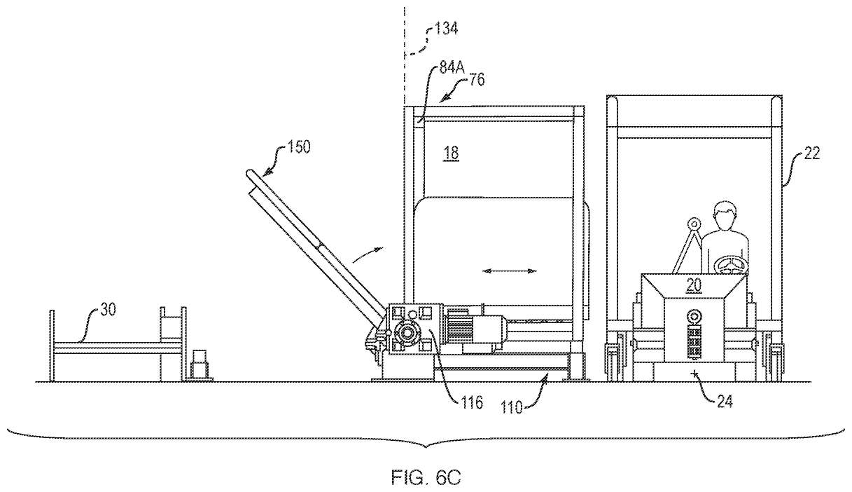

Exemplary system 10 includes at least one automated unloading cell 26 positioned in the baggage arrival area adjacent to the path of travel 24 (see for example FIGS. 5 and 6). As shown in FIG. 2, automated unloading cell 26 is positioned adjacent and in communication with a first transfer device 30, for example a conveyor belt (as shown) and further described below. The automated unloading cell 26 is operable to automatically unload the bags from the delivery carts 22 and position the bags on a first transfer device 30 with no, or minimal, human operator intervention as further described below.

In some embodiments, system 10 includes a manual unloading cell 34 that is positioned in the baggage arrival area 16 downstream of the automated unloading cell 26 as illustrated in FIG. 1. In some embodiments, system 10 includes a manual unloading cell 34 that is positioned in the baggage arrival area 16 upstream of the automated unloading cell 26. In some embodiments, the manual unloading cell 34 is positioned adjacent a second transfer device, for example a belt conveyor 38, as shown in FIG. 2, which merges with the first transfer device 30 to continue as a single transfer conveyor 40 as generally shown and further described below.

In some embodiments, the system 10 further includes a bag scanning system 44 positioned along transfer conveyor 40 upstream of a security screening device 46 whereby the bags 23 pass through the screening device 46 and are screened for illicit or other hazardous materials further described below.

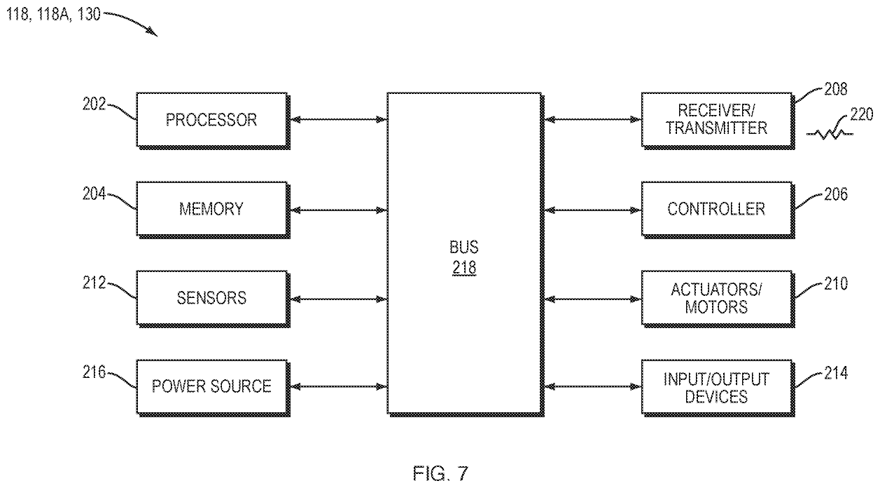

Referring to FIG. 1, in some embodiments, system 10 further includes a carousel diverter device 50 which serves to selectively divert bags 23 to an assigned or designated one of a plurality of baggage carousels 58 (three shown) where passengers pick-up or reacquire their bags 23. One or more of baggage carousels 58 may be designated by a predetermined metric, for example by incoming flight number. The diverter device 50 operates to selectively divert bags to the designated carousel as determined by an arrival area control system 114 described further below and illustrated in FIG. 7.

Referring to FIGS. 1 and 2, tin some embodiments he system 10 includes a plurality of delivery carts 22 each operable to support and transport a container filled with bags 23 for delivery to the terminal bag arrival area 16. As described above, the delivery carts are moved along path of travel 24 and are positioned adjacent and aligned with an automated unload cell 26 for unloading of the plurality of bags. In some embodiments, each delivery cart 22 includes a horizontal base, vertical end walls on the front and rear ends, and a canopy or roof extending between the vertical end walls. The base, vertical end walls and canopy define at least one open side, opposing open sides defining an interior cavity of size to receive, for example, a container 18 housing a plurality of arriving bags 23. Three or more wheels support the base allowing the delivery cart 22 to travel on a hard ground surface. A hitch of the connector device allows the lead delivery cart 22 to removably connect to a transfer vehicle 20, and to connect additional delivery carts 22 to form a “train” of delivery carts.

In some embodiments, each delivery cart 22 includes a roller platform device operable to move the container(s) 18 into and out of the delivery cart 22 as further described below. Other structures, forms, components and configurations for the construction and function of the delivery carts 22 to suit the particular application and performance requirements may be used. In some embodiments, the container 18 is in the form of a unit load device (ULD). Other forms of containers having at least one open, or openable (normally vertical) side for passage of bags therethrough as further described below may be used. As noted above, in some embodiments, e ULD dollies, loose baggage trailers, and other devices may be used. In some embodiments, the delivery carts 22 may be supported and propulsion provided by, an autonomous automated guided vehicle (AGV) which is controlled, navigated and/or directed by an AGV internal control system and/or an area central control system 118.

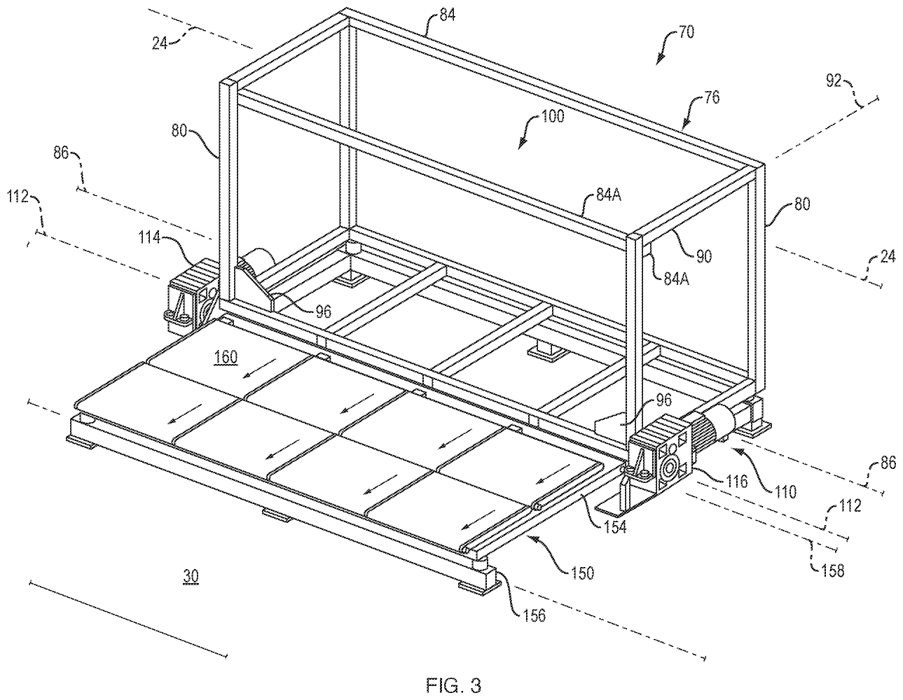

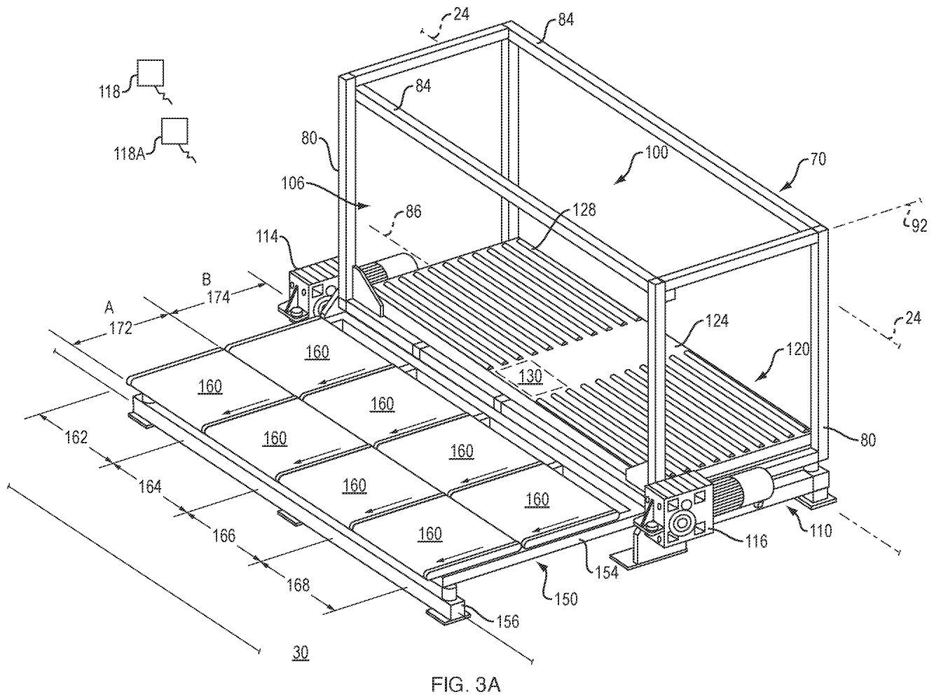

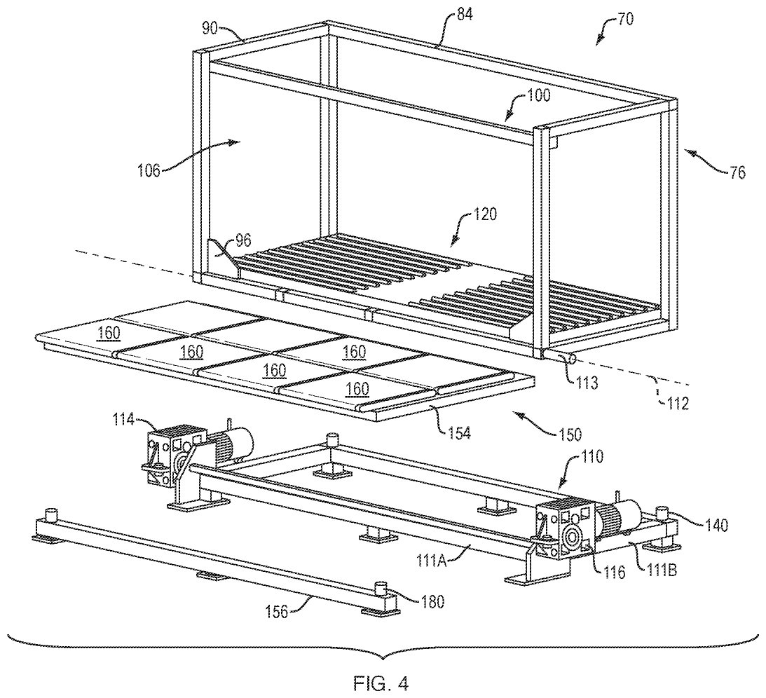

Referring to FIGS. 3, 3A and 4, an exemplary baggage container roller deck 70 is illustrated. In some embodiments, the baggage container roller deck 70 is used in an exemplary system 10. In some embodiments, the baggage container roller deck 70 includes a generally square or rectangular-shaped rotatable deck frame 76. In some embodiments, the deck frame 76 includes pillars 80 (four shown), longitudinal cross-members 84 (four shown), lateral cross-members 90 (four shown) and one or more container stops 96 (two shown). In some embodiments, the pillars 80 and cross-members 84, 90 form a rigid frame structure.

In some embodiments, the deck frame 76 includes an open front side 100 for receiving baggage containers 18 housing the bags 23 (described below) and an opposing, substantially open rear side 106 allowing for bags 23 to pass through as further described below. Additional and/or alternate pillars, cross-members, structures, configurations, orientations and materials may be used for the deck frame 76.

Still referring to FIGS. 3, 3A, and 4, in some embodiments, the container roller deck 70 includes a deck base 110 for securely supporting deck frame 76. As shown in FIG. 4, the deck base 110 includes rigid longitudinal cross-members 111A (two shown) and lateral cross-members 111B (two shown) which are fixedly secured to a ground surface. The deck base 110 can include additional and/or alternate structures, configurations and orientations.

In some embodiments, the container roller deck 70, and the deck frame 76 define an axis of rotation 112 (FIGS. 3 and 4) allowing the deck frame 76 to rotate relative to the deck base 110 as described further below. In some embodiments, an axle 113 longitudinally extends from both sides of the deck frame 76 as generally illustrated. In some embodiments, one end of the axle 113 is received in a deck frame drive device 116 mounted to the deck frame 110 (FIG. 4). The opposing end of the axle 113 is received and engaged in a bearing housing and support connected to the deck base 110.

In some embodiments, the deck drive 116 is a bi-directional (clockwise and counterclockwise) electric motor in communication with arrival area control system 118. Deck drive 116 receives and engages one end of the axle 113. The control system 118 selectively activates or energizes the deck drive device 116 to selectively rotate the deck frame 76 about the axis of rotation 112 as further described below. It is understood that that the deck frame axle 113 configuration and engagement between the axle 113 and the deck drive 116 can take other forms, structures and engagement schemes. It is further understood that the described exemplary electric motor for the deck drive 116 can take other structures, devices and forms effective to rotate the deck frame 76 about the axis of rotation 112 in the manner described below.

In some embodiments, the container roller deck 70, and an index table 150 (described further below), are operated and controlled by a local or container roller deck control system 118A in communication with the arrival area control system 118. The container roller deck control system 118A includes one or more of the components shown in FIG. 7 and further includes software, operating systems and other features and functions described for control system 118. Control system 118A, as well as the other control systems generally described herein, are in communication with one another, include one or more of the components, software and operating systems in FIG. 7, are collectively referred to herein as control system 118 for ease of description and/or illustration.

Referring to FIGS. 5 and 6A-6C, an example of rotational movement of deck frame 76. In some embodiments, the deck frame 76 can include an attached powered roller platform 120 as illustrated in FIGS. 3A and 4. In an exemplary embodiment of the automated unloading cell 26, for example, the beginning of an automated baggage unloading cycle, the deck frame 76 is positioned in a first position 134 shown in FIG. 5 with the deck frame 76 in a generally upright or vertical position relative to the deck base 110. As illustrated in FIG. 6A and as further described below, when initiated or energized by, for example the area control system 118, the deck drive 116 rotates the deck frame 76 about the axis of rotation 112 from the first position 134 to a second position 136. In some embodiments, the deck frame 76 can be rotated approximately 65-70 degrees from the first position 134 to the second position 136. It is understood that the second position 136 may be at alternate greater or lesser angles, for example 45, 55, 75, 80, 85 or 90 degrees (substantially horizontal).

As further described below, in some embodiments, on activation/re-energizing of the deck drive 116, for example by the area control system 118, the deck drive 116 rotates the deck frame 76 from the second position 136 to a third position 138 as illustrated in FIG. 6B. In some embodiments, the deck frame 76 can be rotated approximately 25-30 degrees from the second position 136 back toward the first position 134, until the deck frame 76 reaches the third position 138. As further described below, in some embodiments, on activation of the deck drive 116 by the control system 118, the deck frame 76 is rotated from the third position 138 back to the first position 134 as seen in FIGS. 5 and 6C. Stops 140 may be connected to deck base 110 to abuttingly engage the deck frame 76 returning to the first position 134 to prevent further rotational movement. Other angular positions for the first position 134, the second position 136, and third position 138, and angular movements or paths of travel, for the deck frame 76 suitable for the application and performance specifications may be used.

Referring to FIGS. 3A and 4, in some embodiments, the deck frame 76 includes a powered roller platform 120 operable to engage and transfer containers 18 housing into and out of, the deck frame 76 as further described below. The powered roller platform 120 includes a relatively low profile base 124 having a longitudinal axis generally parallel to the deck frame axis of rotation 112. A plurality of elongated rollers 128 are rotatably connected to the base 124 and are rotatable relative to the base 124. In some embodiments, the powered roller platform 120 is a separate device that is removably, but securely connected to the deck frame 76. In some embodiments, the powered roller platform 120 may be integral to, or built into, the deck frame 76.

In some embodiments, rollers 128 rotate about respective axes parallel to the longitudinal axis thereby assisting movement of the baggage containers 18 in a direction 92 transverse to the longitudinal axis 86 (see FIG. 3A). It is understood that different forms, greater or lesser numbers, types, and configuration of rollers 128 may be used. Rollers 128 may further have different orientation and rotation relative to base 124 to suit the application.

In some embodiments, the powered roller platform 120 includes the internal control system 130 generally including executable and configuration software as well as several, or all, of the hardware components shown in FIG. 7, and as described for control systems 118 and 118A, and as further described below. In some embodiments, the powered roller platform 120 includes one or more actuators, for example, electric motors 210, connected to the rollers 128 to selectively rotate the rollers 128 in a selected direction (laterally into or out of deck frame 76) relative to the base 124. Platform control system 130 can be in communication with the arrival area control system 118 and may receive hardwire or wireless signals to engage/energize or disengage/de-energize the actuator(s) 210, as well as the direction of the rotation, according to preprogrammed software and/or instructions in the area control system 118 and/or the platform control system 130. The powered roller platform 120 and/or the roller deck 70 may further include one or more sensors 212 to, for example, detect if the container 18 is positioned correctly or incorrectly on the powered roller platform 120. In some embodiments, the one or more sensors 212 can be optical sensors. Other components, devices, and/or configurations of the powered roller platform 120 may be included to suit the particular application and performance requirements.

Referring again to FIGS. 1 and 2, each exemplary delivery cart 22 can include a roller platform connected to the delivery cart base or floor under the canopy. The delivery cart roller platform may be of similar components and construction described for the deck frame 76 and the powered roller platform 120. In some embodiments, the delivery cart roller platform can include rollers that are not powered by a power source and actuators as described for the powered roller platform 120. Instead, the delivery cart roller platform rollers can be idler rollers, which may freely rotate under a transverse or lateral load on the rollers.

In some embodiments, system 10, a secondary or parasitic drive-type device can be used to aid in the automated transfer of the container 18 between the respective delivery carts 22 and the deck frame 76. In some embodiments, the powered roller platform 120 includes a rotatable shaft that can automatically be extended and engage a cooperative receptacle on the delivery cart roller platform. The rotatable shaft can be automatically extended when, for example, sensors or other vision devices confirm and verify the horizontal (x coordinate direction) and vertical (z coordinate direction) alignment of the delivery cart 22 to the deck frame 76. In some embodiments, the sensors can be optical sensors.

The delivery cart roller platform rollers are connected to an internal roller drive device, which is connected to the rollers. On engagement of the extended rotatable shaft with the delivery cart roller platform receptacle, and activation of the powered roller platform 120, for example by the central control system 118, the rotatable shaft transfers rotation to the delivery cart roller platform receptacle and rotates the delivery cart rollers in a coordinated direction (either to move a container 18 toward the powered roller platform 120 or away from the powered roller platform 120 into the delivery cart 22). One or more sensors and/or vision devices may be used to monitor and verify receipt and proper positioning of the container 18 on one of the powered roller platform 120 or the delivery cart 22. In some embodiments, the one or more sensors can be optical sensors. Devices and processes other than the described secondary/parasitic drive device may be used to transfer power or motion from the powered roller platform 120 to the delivery cart roller platform.

In some embodiments, the delivery carts 22 can include a powered roller platform 120 as described for deck frame 76. In some embodiments, the delivery cart powered roller platform can also include a power source, for example a rechargeable battery. In some embodiments, when the delivery cart is aligned with the deck frame 76, the delivery cart 22 docks or engages with a source providing electrical power to the powered roller platform. In embodiments of independent activation of a delivery cart powered roller platform, the activation and movement of the rollers can be coordinated through receipt of data signals received from the arrival area control system 118.

Referring back to FIGS. 3, 3A, 4, and 5, in some embodiments, the container roller deck 70 includes an index table 150 for use in the automated unloading cell 26. In some embodiments, the index table 150 is rotatably connected to the deck frame 76 and rotatable relative thereto about an index table axis of rotation 158 (FIG. 6B). As illustrated in FIG. 5, the index table 150 includes an index table frame 154 including, for example longitudinal and lateral cross members providing a rigid platform. As illustrated in FIGS. 3A, 4 and 5, in some embodiments, the container roller deck 70 includes an index table base 156 for selective abutting engagement with the index table 150 as further described below.

Referring to FIGS. 3, 3A and 4, the index table 150 includes an index table conveyor 160 operable to receive bags 23 released from the container 18 positioned in the deck frame 76 as further described below. In some embodiments, the index table conveyor 160 is operable to automatically, and selectively, advance or transfer the bag 23 positioned on the conveyor 160 toward the first transfer device 30 (FIGS. 2 and 6B).

In some embodiments, the index table 150, and the index table conveyor 160 includes a plurality of individual index conveyors 160 (eight (8) shown) connected to the index table frame 154 and each rotatable relative thereto. Each conveyor 160 is independently rotatable (or advanceable) relative to the other conveyors 160 to selectively move or advance a bag 23 positioned on a particular conveyor 160 relative to the other conveyors 160. This independent movement capability of each conveyor 160 provides a high level of flexibility and control to selectively advance and position bags positioned on a specific conveyor 160 as further described below.

In some embodiments, the conveyor 160, a continuous or endless belt is engaged with a drum roller (having integrated therein a motorized device operable to turn the roller, and necessarily the belt) rotatably connected to the index table frame 154. In some embodiments, each conveyor 160 includes a drum roller that is in hardwire or wireless communication with the control system 118 to selectively activate or energize the drum roller(s) to rotate and move or advance the respective belt relative to the index table frame 154, and other conveyors 160.

As illustrated in the FIGS. 3, 3A, exemplary use of the illustrated eight conveyors 160 are organized in four rows and two positions (a front and a rear). In some embodiments, a first row 162, a second row 164, a third row 166 and a fourth row 168 are used. As illustrated, each row 162, 164, 166 and 168 row includes an individual belt in a front position 172 (positioned toward the first transfer device 30) and an individual belt in a rear position 174. Selected activation of individual conveyors 160, in an individual row or pairs of rows 162, 164, 166 and/or 168, and/or conveyors 160 in the front position 172 and/or the rear position 174, may be utilized. Use of the disclosed plurality of oriented conveyors 160 provides flexibility and control in the movement and transfer of bags 23 positioned on the conveyor(s) 160 as further described below.

It is understood that the number, configuration, orientation, implementation, and construction of the described conveyors 160 can vary to suit the particular application and performance requirements. For example referring to FIG. 3A, conveyor 160 can in some embodiments take the form of a single conveyor 160 (spanning all of the rows and the front and rear positions as illustrated), two conveyors 160 positioned side by side (each spanning two rows and both the front 172 and rear 174 positions), four conveyors positioned side by side (each spanning one row and both the front 172 and rear 174 positions), two transverse conveyors 160 (each spanning all of the rows, but one in the front position 172 and one on the rear position). Other combinations and orientations of conveyors 160 to suit the particular application.

Referring to FIGS. 5 and 6A-C, as described above, the index table 150 is pivotable and selectively rotatable about the axis of rotation 158 relative to the deck frame 76. In some embodiments, the index table 150 includes a first or vertical position 176 directly adjacent to the deck frame 76 as illustrated in FIG. 5. Index table 150 is positioned in the first position 176 when, for example, the deck frame 76 is in its first position 134 (FIG. 5) at the start of an unloading cycle when the container 18 (shown in the form of a unit load device (ULD)) is moved by the powered roller platform 120 into the deck frame 76. It is understood that the container 18 can take different forms than a ULD as illustrated. In some embodiments, baskets, pallets, trays and other devices suitable for supporting and containing the bags 23, or other packages or parcels in other applications, may be used.

As further described below, on activating/energizing the index table drive 114, the index table 150 may rotate relative to the deck frame 76 from the first position 176 directly adjacent to the deck frame 76 to a second position 178 as illustrated in FIG. 6B rotated away from the deck frame 76. In some embodiments, the index table 150 rotates 20-25 degrees relative to the deck frame 76. In some embodiments, the index table 150 in the second position 178 is in a substantially horizontal position and abuttingly engaged with the index base 156 and the index table stops 180. Other angles, greater or lesser, and movements of the index table 150 relative to the deck frame 76 may be used to suit the particular application.

Referring to FIG. 2, in some embodiments, the automated unload station 26 further includes safety fencing 182 positioned in selected places along the sides the deck frame 76 extending to the first transfer device 30 as generally shown. Safety fencing 182 is used to prevent personnel from mistakenly entering the area between the deck frame 76 and the first transfer device 30 when the automated unloading cell is activated or in an operable status. Other safety devices may be used.

Referring back to FIGS. 1 and 2, n some embodiments, exemplary system 10 includes a manual unloading cell 34 positioned in the baggage arrival area 16 downstream or upstream of the automated unloading cell 26. In some embodiments, the manual unloading station 34 is used to unload bags from the containers 18 that are not suitable for use in the automated unloading cell 26. In some embodiments, the manual unloading station 34 may be used to unload bags 23 that are not suitable for automated unloading, for example oversized or odd sized-shaped bags. In some embodiments, the manual unloading station 34 can serve as a back-up or reserve unloading cell if problems arise in the automated unload cell 26, for example a malfunction or scheduled maintenance.

In some embodiments, the delivery carts 22 are moved along path of travel 24 and are generally positioned or aligned in the vicinity of the manual unload cell 34. In some embodiments, human operators remove the bags 23 from the container 18 and place them on the second transfer device 38. In some embodiments, a level of automation, for example robotic assisted efforts or motions, for example removing or lifting bags from the container 18 to relieve difficult manual effort levels or ergonomics may be used. In some embodiments, automated devices 188, including end effectors operable to engage bags 23, to assist the human bag handlers move the bags 23 from the containers 18 onto the second transfer device 30 may be used. In some embodiments, the automated devices 188 may include a pneumatic vacuum or suction end effector to engage individual bags 23. Alternate automated devices and/or end effectors to suit the particular application may be used.

In some embodiments, the bags 23 positioned on the second transfer device 38 are automatically moved downstream and merge with the first transfer device 30 to form a single transfer conveyor 40. On removal of the last bag 23 from the last container 18 of the last delivery cart 22, the transfer vehicle 20 leaves the baggage arrival area 16 to return to the aircraft stand or other area to receive additional full containers 18 for delivery to the arrival area 16 as described.

Referring to FIG. 7, a block diagram of an exemplary arrival area or central control system 118 is illustrated. The illustrated general control system hardware components together, or combined with additional hardware, are useful for the control system 118, as well an individual device control systems described above. For example the powered roller platform control system 130 (as noted above 118, 118A, 130 and all other control systems described herein are collectively referred to as control system 118 for ease of description unless otherwise noted).

In some embodiments, the control system 118 includes a computing device, or multiple computing devices, working cooperatively. The exemplary control system computing device includes common hardware components, including but not limited to, a processor 202, data memory storage device 204, one or more controllers (including but not limited to programmable logic controllers (PLC)) 206, signal transmitter and receiver 208 for sending and receiving hardwire and wireless data signals 220, actuators 210, and sensors 212. These hardware components are in data signal communication with one another, either through hard wire connections or wireless communication protocols, through a bus 218, or other suitable hardware. Other hardware components, including additional input and output devices 214, to suit the particular application and performance specifications may be used. Examples of input devices include, but not limited to, touch sensitive display devices, keyboards imaging devices and other devices that generate computer interpretable signals in response to user interaction. Examples of output devices include, but not limited to, display screens, speakers, alert lights and other audio or visually perceptible devices. Control system 118 is powered by the power source 216.

Exemplary processor 202 can be any type of device that is able to process, calculate or manipulate information, including but not limited to digital information that is currently known or may be developed in the future. One example of a processor is a conventional central processing unit (CPU). It is contemplated that multiple processors 202 and servers may be needed to support 118. These may be on site at the airport, for example for security concerns, and/or in the “cloud” (cloud computing through remote servers and systems).

The exemplary data memory storage device 204 may include devices that store information, including but not limited to digital information, for immediate or future use by the processor 202. Examples of memory storage devices include either or both of random access memory (RAM) or read only memory (ROM) devices. The memory storage device may store information, such as program instructions that can be executed by the processor 202 and data that is stored by and recalled or retrieved by the processor 202. Additionally, portions of the operating system for the computational device and other applications can be stored in the data memory storage device 204. Non-limiting examples of memory storage device 204 include a hard disk drive or a solid-state drive. Alternately, portions of the stored information may be stored in the cloud (remote storage devices or data centers) and selectively retrieved through wireless protocols.

In some embodiments, control system 118 includes a suitable software operating system and preprogrammed software to execute predetermined actions, functions or operations of the system 10 described herein. The operating system and software may be stored in the data memory storage device 204, and processed and executed by the processor 202 through controller 206 and actuators 210. Other and/or alternate hardware and/or software components may be used to suit the particular application or performance specifications may be used.

Referring to FIGS. 1 and 2, an example of operation of system 10 is disclosed in an example at an airport environment. A plurality of bags 23 are loaded into a respective one of the container 18. Container 18 is loaded onto the delivery cart 22. It is understood that more than one container can be included in each delivery cart 22. One or more delivery carts 22 with a respective loaded container 18 are moved to the terminal baggage arrival area 16 by a transfer vehicle 20 as described above.

Referring to FIG. 2, for containers 18 and/or bags 23 that are suitable for automated unloading, the delivery cart 22 is moved into a position adjacent to an automated unloading cell 26, and more particularly in alignment with the container roller deck 70 as described above. In some embodiments, container 18 is a ULD. Other bag containers 18 may be used. The container 18 is further aligned with deck frame 76 for receipt of the container 18 in deck frame 76. One or more sensors, for example vision sensors or cameras may be used to monitor or verify when the delivery cart and/or container 18 is in proper alignment, for example along the path of travel (x direction) and vertically (z direction) for proper transfer. The one or more sensors can transmit a data signal to the control system 118, indicating that the delivery cart 22 and/or the container 18 is in alignment with deck frame 76. The one or more sensors can transmit the data signal to the delivery cart 22 and/or the container 18 before the control system 118 sends a control signal to the power roller platform 120 to initiate the transfer of the container 18 from delivery cart 22 unto deck frame 76.

In some embodiments, the above-described secondary or parasitic drive is signaled by the control system 118 to extend and engage the cooperative receptacle on the delivery cart roller platform as described above. On initiating or energizing of the powered roller platform 120 to begin movement of the rollers 128, the secondary drive also rotates the rollers on the roller platform on delivery cart 22 thereby laterally transferring the container 18 from the delivery cart 22 into the deck frame 76. One or more sensors in communication with the area control system 118 may be used to stop movement of the powered roller platform and lateral translation of the container 18. As described above, sensors including, but not limited to vision or other sensing devices, may be used to verify the container 18 is positioned in the deck frame 76. For instance, the one or more sensors can determine when the container 18 has been successfully transferred from the delivery cart 22 into the deck frame 76 by detecting when the container 18 interferes with light produced by one or more optical sensors as the container 18 is moved from the delivery cart 22 to the deck frame 76. In some embodiments, one or more sensors, readers or vision systems may be used to scan or otherwise read an identification unique to the container to positively identify the container 18 to, for example, verify the container or bags from a certain flight number or other metric.

Referring to FIGS. 3 and 4, the container stops 96, and upper longitudinal cross member 84A, are used to prevent lateral axis 84 over travel of the container 18 in the deck frame 76. One or more sensors or vision systems in communication with the container roller deck control system 118 may be used to verify the container 18 is properly positioned in deck frame 76 (as shown in FIGS. 5 and 6C). In this position, the deck frame 76 is in the first position 134 and the index table 150 is in the first position 170 (vertical) as shown in FIGS. 5 and 6C.

In some embodiments, system 10 and the container roller deck 70, on verification by the container roller deck control system 118 that the container 18 is properly positioned within deck frame 76, and for example, that the index table 150 is in the first position 176, the control system 118 may send an electronic signal to the deck frame drive 116 to rotate the deck frame 76 from the first position 134 to the second position 136 as shown in FIG. 6A. In the example second position 136 shown in FIG. 6A, the deck frame 76 is rotated about 65-70 degrees. In some embodiments, the second position is about 45, 55, 75, 80, 85 or 90 degrees. It is understood that a greater or lesser angle of rotation may be used to suit the application and performance.

In some embodiments, rotation of the deck frame 76 and the container 18 from the first position 134 to the second position 136 as shown in FIG. 6A, the index table 150 remains in the first position 176 directly adjacent to the deck frame 76 to keep the bags 23 from releasing or exiting from the container 18. In some embodiments, an open side of the container 18, on reaching the second position 136, most, if not all of, the bags 23 are no longer supported by the container 18 and by the force of gravity, are positioned on, and substantially supported by, the index table 150. One or more sensors and/or vision systems may be used to verify that the deck frame 76 is in the second position 136 and signal the control system 118. The one or more sensors and/or vision systems can include one or more optical sensors.

Referring to the FIG. 6B, on verification by the control system 118 that the deck frame 76 is positioned in the second position 136, the control system 118 signals or otherwise activates the index table drive 114 to rotate the index table from the first position 176 to the second position 178 (substantially horizontal in some embodiments) to abuttingly engage the index base 156 and the stop 180 as generally shown. In some embodiments, the index table 150 rotates away from its first position 176 about 25-30 degrees. It is understood that greater or lesser angles of rotation may be used to suit the application.

As illustrated in FIG. 6B, in some embodiments, one or more sensors (including vision camera devices) detect and/or verify that the deck frame 76 has reached the second position 136 and signal the control system 118. On such verification, transfer of the bags 23 from the index table 150 can begin as discussed below. The one or more sensors and/or vision systems can include one or more optical sensors.

After verifying that the deck frame 76 is in the second position 136, and the index table 150 is in the second position 178, the control system 118 can send signals or otherwise activate the deck frame drive 114 to rotate the deck frame 76 from the second position 136 to the third position 138 as described above. In some embodiments, the third position 138 is about 20-25 degrees from the second position 136. In some embodiments, the third position 138 may be about 5, 10, 15, 20, 35, 45 or 55 degrees, and positions in between, from the second position 136. This exemplary rotation from the second position 136 to the third position 138 is advantageous for a more controlled deposit and placement of the plurality of bags 38 on index table 150.

It is understood that angles greater or lesser than the examples provided may be used to suit the particular application. One or more sensors, including, but not limited to vision systems, can be used to detect or verify that the deck frame 76 is positioned in the third position 138 and send a signal to the control system 118. It is further understood that rotation from the second position 136 to the third position 138 can be eliminated and the deck frame 76 can be rotated from the second position 136 back to the first position 134 as described below. It is also understood that additional positions, for example, a fourth or more positions positioned at angles between the third 138 and first 134 positions may be used.

In some embodiments, the container roller deck 70 as illustrated in FIGS. 6B and 6C, based on a desired condition, or other metric, the control system 118 can send an electronic signal to the deck frame drive 116 to return the deck frame 76 from the second position 136 back to the first position 134 as illustrated in FIG. 6C. While the deck frame 76 rotates from the second position 136 to the first position 134, and from the third position 138 back to the first position 134, the index table 150 remains in the second position 178 as illustrated in FIG. 6B (thereby allowing the deck frame 76 to rotate relative to the index table 150). One or more sensors (including vision camera devices) may detect that deck frame 76 has reached the first position 134 and signal the area control system 118 to verify the deck frame position.

On detection or verification through one or more sensors, including, but not limited to one or more position sensors, for example an encoder or a switch, one or more optical sensors, or vision systems, that the deck frame 76 has returned to the first position 134, the control system 118 sends control signals to the powered roller platform 120 and the delivery cart roller platform, that cause the roller platform 120 and the delivery cart roller, to activate which initiates rotation of the respective platform rollers in the opposite direction to return the container 18 back onto the delivery cart 22 in a manner previously described. This returning of the container 18 to the delivery cart 22 may occur prior to, or simultaneous with the advancement of bags from the index table 150 as described below.

Referring to FIGS. 6B and 3A (no bags shown in FIG. 3A for ease of illustration), due to the force of gravity, the bags 23 are often deposited across several of the plurality of conveyors 160 (exemplary eight conveyors 160 shown as described above). In some embodiments, it is advantageous for further travel along first transfer device 30, the transfer conveyor 40, the bag scanning system 44, and for security screening by screening device 46, if each bag is positioned sequentially (one after another in a single file line) on the first transfer device 30 (versus overlapping or bunched/stacked atop one another). It is further advantageous, for the bag scanning array and security screening by device 46, if each bag 23 is separated by a predetermined distance from the adjacent upstream and downstream bag 23.

To aid in separating the bags 23 positioned atop of the index table 150, the conveyor 160 aids in separating the bags 23 a desired or selectable distance on the first transfer device 30. One or more of the individual conveyors 160 may be activated and advanced to selectively and sequentially move the bags 23 from the index table 150 onto the first transfer device 30. In some embodiments, where one or more bags are deposited on one or more of the conveyors 160 positioned on the front belts (area 172), one or more of the conveyors 160 positioned in the front belt area may be activated to advance the bags 23 positioned on these respective conveyors 160 closest to the first transfer device 30 to orderly and sequentially begin moving the bags 23 off the index table 150. In some embodiments, the conveyors 160 positioned in the front belt area 172 may be activated to selectively advance the bags 23 positioned only on those belts while bags 23 positioned on the other conveyors 160 positioned in the front belt area 172 remain stationary. For instance, simultaneously activating the conveyor 160 positioned in first row 162/front belt 172 and third row 166/front belt 172 serves to advance bags that are already separated by a distance when those bags 23 are deposited on first transfer device 30. Following advancement and deposit of these bags, the conveyors 160 are stopped and the other conveyors, for example, second row 164/front belt 172 and fourth row 168/first belt 172 may be simultaneously activated to sequentially advance bags positioned on those conveyors in the same manner achieving the same advantages as described. Once all the bags 23 have been advanced from the conveyors 160 positioned in the first belt area 172, the process can continue for the conveyors 160 positioned in the rear belt area 174.

It is understood that individual and coordinated activation of the conveyors 160 may vary depending on various metrics, for example how the bags have deposited and/or spread out across the index table 150 across multiple conveyors 160. As mentioned, the activation and advancement of the conveyors 160 is achieved through receipt of hardwire or wireless signals from the area control system 118.

In some embodiments, detection by one or more sensors, for example vision camera devices, and analysis by control system 118 determines which of the conveyors 160 is activated and when. For example, following rotation of the deck frame 76 to the third position 138 and/or back to the first position 134, a vison device camera may image the spread and location of the bags 23 across index table 150 and send data associated with the imaged spread and location of bags 23, to control system 118. In turn, for example, the data is analyzed by software programs and a sequence of activation of the conveyors 160 in the manner described above takes place. The data can be processed by the processor 202, saved in memory 204, and executed to optimize advancement of the bags 23 from the index table 150 to the first transfer device 30 to maximize the above mentioned advantages, for example sequential order and separation of the bags 23. As mentioned above certain metrics can be used to determine how to optimize the advancement of the bags 23 from the index table 150 to the first transfer device 30. Exemplary metrics can include the size of the bag (e.g., length, width, height), the orientation of the bag with respect to a perpendicular and horizontal plane, the proximity of the bag relative to other bags, the position of the bag on conveyors 160. For example, the processor 202 can be programmed to determine an objective function that is associated with the timing of advancing the bags 23 from the first row of the index table 150 to the first transfer device 30, which is based on a set of constraints associated with one or more of the above metrics.

In some embodiments, predetermined individual or coordinated conveyor activation sequences which have been, for example, tested and proven to achieve one or more desired metrics, for example, sequential order and distance between bags 23 on first transfer device 30, could be prestored in the memory device 204 and executed by processor 202 to independently activate, or through coordinated activation, one or more conveyors 160 in the manner described above. Other devices and methods used to selectively activate conveyors 160 to achieve the above-identified advantages, or other advantages.

On advancement of all of the bags 23 from the index table 150 to the first transfer device 30, verification that all of the bags 23 have been removed may be made by one or more sensors 212 (including vision camera devices) and the verification signaled to the area control system 118. Referring to FIG. 6C, on verification that all of the bags 23 have been cleared from index table 150, the control system 118 signals or otherwise activates the index table drive 114 to rotate index table 150 from the second position 178 back to the first position 176 as generally shown. Other devices and methods, for example, switches and encoders may be used to verify and return the index table 150 to the first position 176. On verification that the index table 150 is positioned at the first position 176, the container roller deck 70 is ready to begin the process of accepting another container 18 as described above.

As described above, once the container 18 has been transferred and verified to be positioned back on the delivery cart 22, in one example, the transfer vehicle 20 moves the delivery cart 22 to the manual unloading area 34 to, for example, verify that no bags 23 remain in the container 18. If additional connected delivery carts 22 include bags to be unloaded in the manual unloading station 34, that delivery cart 22 is positioned in the manual unloading area and unloaded as described above.

Referring to FIG. 2, in some embodiments, use of one or more singulation conveyors 190, (four shown) is illustrated. In some embodiments, use of singulation conveyors are used to further separate, increase the distance between, the sequentially positioned bags 23 traveling along the first travel device 30 (advantages described above, for example the bag scanning array and security screening). In some embodiments, one or more (four shown) singulation conveyors 190 are positioned along, and disrupting, the path of travel of first travel device 30, for example in the form of a continuous belt conveyor. In some embodiments, one or all of the singulation conveyors 190 may be positioned along the transfer conveyor 40 (FIGS. 1 and 2).

In some embodiments, each singulation conveyor of the singulation conveyors 190, may consist of a drum motor (described above for conveyors 160), or electric motors and related devices. One or more sensors may monitor metrics of the conveyor, for example rate of advancement, and convey that data through hardwire or wireless signals to a conveyor control system 118B. Conveyor control system 118B may include one or more of the components in FIG. 7 as well as software and operating systems generally described herein for area or central control system 118.

In some embodiments, each of the singulation conveyors of the singulation conveyor 190 is an independently controllable conveyor belt from the other conveyors of the singulation conveyor 190, and the first transfer device 30. In some embodiments, the velocity or rate of advancement (feet or meters/minute) of the singulation conveyor 190 is different from the rate of advancement of the first transfer device 30 to selectively separate the bags 23, or increase the distance between adjacent bags, to achieve a predetermined distance, or a preferred or workable distance, for example ensuring there is at least a small linear distance separation between adjacent bags 23 for bag scanning and security screening purposes.

In some embodiments, the singulation conveyor 190 can include a single conveyor that has a constant rate of advancement that is greater than the rate of advancement of the first transfer device 30. For the bag 23 passing from the slower first transfer device 30 to the faster moving singulation conveyor 190, there imparts a greater linear distance between the bag 23 that is on the singulation conveyor 190, and another bag that is upstream from the bag 23, that is on first transfer device 30. Use of additional numbers of conveyors 190 positioned sequentially provides more flexibility to impart a desired distance between the sequentially moving bags 23.

In some embodiments, the rate of advancement of the conveyor 190 can be rapidly varied to adjust to the oncoming distance between the bags 23 to further achieve the desired distance between bags. In one example, sensors (including a vision camera device) may monitor and detect the distance between adjacent bags, or bags 23 that are positioned parallel, or side by side, on first transfer device 30, and send a control signal to the control system 118. The received control signal can be analyzed by software stored in memory 204, and calculations made by processor 202 can cause the control system 118 to send a control signal to the conveyor 190 to actively adjust the rate of advancement of the conveyor 190 to better achieve a desired distance between bags 23. Other devices, for example different numbers of conveyors 190 and their positions along first travel device 30, and methods for singulation conveyor 190 may be used.

In some embodiments, a baggage orientation device may be positioned along the path of travel of the first transfer device 30 or the first transfer conveyor 40 to further reorient and separate the bags 23 that are not sequentially positioned and/or do not have a predetermined separation distance between the bags 23. In some embodiments of a baggage orientation device, a sensor, including but not limited to a vision system, is used to detect bags traveling along transfer device 30 or conveyor 40 that do not have a desired separation. In some embodiments, the sensor can include an optical sensor. In some embodiments, two narrow singulation conveyors positioned side by side can be used to separate bags positioned side by side. In some embodiments, one or both of the side by side conveyors have independently controlled rates of advancement as described above for singulation conveyors 190.

On detection by sensors or vision system of two bags 23 that are positioned side by side (and will each travel over one of the side by side orientation device belts) one of the orientation device belts rate of advancement can be different than the other side by side orientation belt to create a separation or distance between the bags.

Referring to FIG. 2, in some embodiments, system 10 includes a bag scanning system 44 positioned along the path of travel of the transfer conveyor 40 as generally shown. In some embodiments, the bag scanning system 44 can be a multi-sensor or multi-beam optical scanning array operable to scan or read predetermined metrics, for example the bag tag, including for example a bar code, QR code or RFID tag, attached by the airline to each bag including a unique identification number. Data read or otherwise obtained by the bag scanning system 44 can be communicated to the control system 118 to register or verify the bag 23 has been received back into system 10 or a larger central airport control system. In some embodiments, the scanned data for a particular bag can be referenced against other data previously recorded for that metric to, for example, identify suspicious differences between the present data and prior data. Other metrics can be scanned or otherwise obtained, for example, verifying the bag is from a particular flight number, and/or passenger class of service or special reward program status handling, so the bag can be selectively directed to the proper bag carousel 58 or other designated area. Other devices, processes and data for bag scanning system 44 to suit the particular application may be used.

In some embodiments, following passage of bags 23 through the bag scanning system 44, a manual bag tagging station may be used. In some embodiments, if a bag passes through the bag scanning system 44 without a bag tag (or other identification tag such as a radio frequency ID (RFID) tag), the bag may be removed or otherwise re-routed to an alternate conveyor or station where a separate or special tag may be attached. This special tag can be used later in the process to identify this particular bag of interest, for example additional screening or security inspection prior to delivery to a bag carousel 58.

As illustrated in FIG. 2, in some embodiments, system 10 includes a baggage screening area or device, for example screening system 46 positioned along the path of travel of the transfer conveyor 40 as generally shown. Although the arrival of bags having already been cleared from dangerous materials prior to loading onto an airplane, often arrival bags are again screened for other materials, for example contraband, before delivery to passengers. Other reasons for screening may include security, revenue protection or other protocols defined by local authorities for law enforcement or public protection.

Exemplary screening system 46 is in communication with control system 118 and be remotely monitored. Screening system 46 may use, for example x-ray, computerized tomography (CT), or other devices and methods. In some embodiments, screening system 46 may selectively be activated or deactivated to screen the bags 23 based on the incoming flight and/or bags, security status conditions or levels at the airport 14 and other factors. Other baggage screening devices, locations, and processes, for example customs or other law enforcement procedures, may be used to suit the particular application and performance specifications.

Referring to FIG. 1, in some embodiments, following passage or clearance by the baggage screening system 46, the plurality of bags 23 are advanced along the transfer conveyor 40 toward bag carousels 58 for pick-up or reacquisition by passengers. In some embodiments, a carousel diverter device (generally 50) is used to divert and direct the bags 23 to a designated carousel 58, for example designated by flight number. In some embodiments, the diverter device 50 includes a multi-positional gate which is in communication with the control system 118, which in combination with an actuator 210 connected to the gate, controls the position of the gate, for example to selectively divert bags to certain of the three carousels 58 shown in FIG. 1. In some embodiments, the system is not associate with any bag carousels.

In some embodiments, scanned data from the bag data tag may be used to direct the position of the diverter to direct bags on the transfer conveyor from different flights to the proper designated carousel for that particular flight. In some embodiments, the bags 23 that are scanned and specially tagged as bags of interest noted above may be diverted to a special area where additional security or inspection processes may be executed. In some embodiments, the specially tagged bags of interest may sound an alarm when the bag is retrieved and crosses through a certain area to alert security officials. Other metrics that may be used by device 50 to sort or specially direct scanned bags to a carousel 58, or other designated area, include passenger class of service, frequent flyer program status, and other metrics. Other devices and methods for sorting and/or diverting bags 23 to a previously designated carousel 58 (or other destination) may be used.

Once past diverter device 50, the bags 23 travel along respective carousel feed conveyors 54 for delivery to the predetermined carousel 58 (or other destination) for pick-up by passengers.

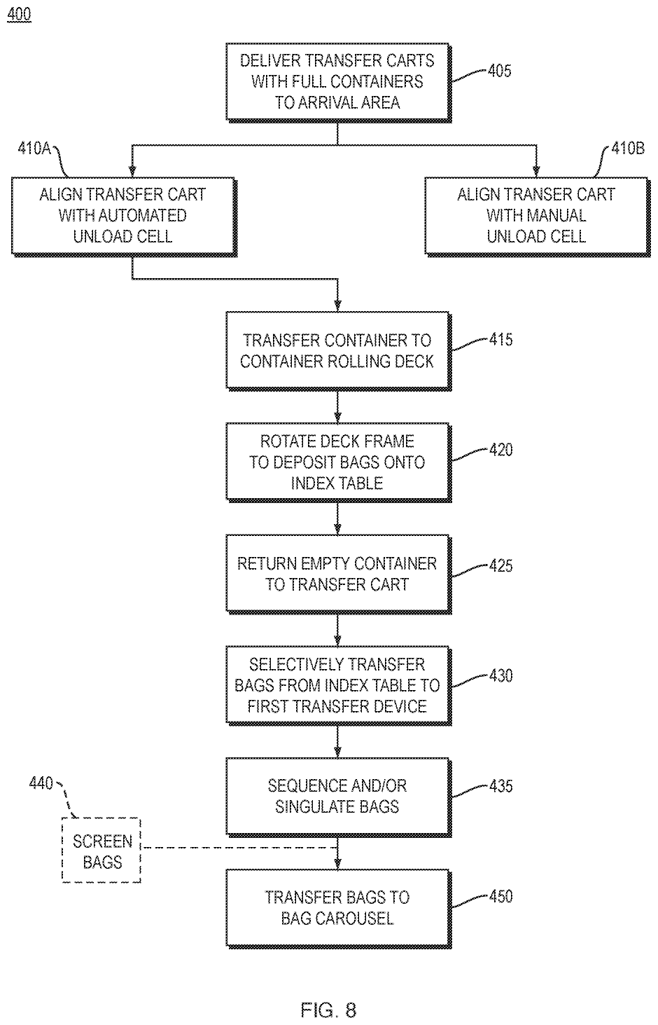

Referring to FIG. 8, in some embodiments, a method 400 for unloading bags from a transit vehicle to a transit terminal is illustrated. In one application, the transit vehicle is a passenger or cargo airplane and the transit terminal is an airport baggage terminal where passengers pick-up or reacquire their checked bags.

In one application in an airport environment, one or more containers 18 are filled, or partially filled, with a plurality of bags 23 unloaded from an airplane. If a large airplane in which containers 18 in the form of ULDs travel in the airplane baggage hold, the ULD containers 18 are unloaded from the plane and loaded onto the travel carts 22. In smaller airplanes, the bags 23 may be manually unloaded from the plane and manually loaded into the container 18 (for example a ULD) and positioned on the travel cart 22.

In step 405, one or more of the delivery carts 22 each carrying one or more of the containers 18 housing a plurality of the bags 23 is driven or delivered by the transport vehicle 20 to the terminal bag arrival area 16 as described above.

In step 410A, if the container 18 and the bags 23 housed therein are suitable for automated unloading, the travel cart 22 and the onboard container 18 is positioned adjacent to the automated unloading cell 26 and further aligned with the container roller deck 70 for automated unloading of the container 18 as described above. Sensors may be used to align the container with the deck frame 76 as described above.

In some embodiments, a step 410B, takes place. If the container 18 or onboard bags 23 are not suitable for automated unloading in the automated unloading cell 26, the container 18 is delivered to the manual unloading cell 34 for manual or semi-automated unloading of the bags as described above.

In step 415, in the automated unloading cell 26, the loaded container 18 is transferred from the travel cart 20 to the deck frame 76. In some embodiments, the powered roller platform 120 on the deck frame 76 coordinates advancement of the container 18 with a roller platform on the travel cart 22 to laterally transfer the container 18 from the travel cart 22 into the deck frame 76 as described above. In some embodiments, a secondary or parasitic drive-type device may be used to provide power or rotation to the delivery cart roller platform. Activation and advancement of the powered roller platform 120 may be controlled by the control system 118 described above (which includes the local or area control systems, and device control systems described herein) and generally illustrated in FIG. 7. Sensors may be used in communication with the control system 118 may confirm or verify the container 18 is properly positioned in the deck frame 76.

In some embodiments, the deck frame 76 includes an index table 150 rotatably connected to the deck frame 76. In step 420, the deck frame 76 is automatically rotated by a deck frame drive 116 from a first position 134 to a second position 136 as described above. On or about reaching the second position 136, the plurality of bags 23 are released or dislodged from the container 18, for example by gravity force, and positioned on the index table 150 as described above. Sensors may be used to detect or determine if the bags have been released or existed from the container.

The deck frame 76 is then rotated from second position 136 to the third position 138 and then back to first position 134 as described above. The index table 150 supporting the deposited bags remains in the second position 178 as described above.

In step 425, the container 18 is then transferred from the deck frame 76 back to the delivery cart 22 through use of the powered roller platform 120, as described above. The one or plurality of connected, delivery carts 22 can then be advanced and the next delivery cart 22 with a container 18 suitable for automated unloading can be positioned and aligned with the container rolling deck 70 while the bags are transferred from the index table 150. Alternately, the delivery cart 22 with the empty container is transferred to the manual unloading station 34 as described above. In an example where multiple carts 22 are connected together, a sensor or vision system will detect when the last cart 22 in the connected line has received the returned container 18, and the sensor or vision system can send a signal to the control system that the line of connected carts can be moved to the manual unloading area in the manner described above.

In step 430, using index table 150 described above, a plurality of independently operable conveyors 160 are individually, or in a coordinated fashion, selectively advanced to selectively transfer bags positioned on the index table 150 onto the first transfer device 30 as described above. One or more sensors (including vision systems) and a control system may be used to actively determine the sequence of activations of the respective conveyors 160 to efficiently transfer the bags 23 from the index table 150 to the first transfer device 30. Alternately, preprogramed and stored sequences of conveyor 160 activations may be used as described above. It is understood that step 430 can occur simultaneously with step 425.

In step 435, in part through use of selective activation of conveyors 160 in step 430, the bags 23 deposited on the first transfer device 30 may be sequenced and/or singulated to provide a predetermined or preferred linear distance between adjacent bags 23 on the first transfer device 30 as described above. As noted above, one or more singulation conveyors 190 may be used. As noted above additional bag singulation or reorientation devices may also be used to separate the bags 23.

In optional step 440, the bags 23 traveling on the transfer conveyor 40 may pass through a bag scanning system 44 as described above. Optionally, the bag 23 then pass through a baggage screening system 46 to check for predetermined, illicit and/or hazardous bag contents as described above. Alternately, or in addition to, the screening device may scan the bag for additional data, for example the airline bag data tag attached to the bag 23, to assist sorting and/or routing the bag to a final destination area, for example bag carousels 58. The screening device 46 can be selectively activated to screen certain groups or flights of bags to meet security levels or other revenue or law enforcement protocols.

In some embodiments, a step 450 is included. In step 450, the bags 23 are transferred to predetermined or designated bag carousels 58 as described above. In some embodiments, a diverter 50 is used to selectively direct the bags 23 to a predetermined carousel, for example by flight number.

It is understood that method 400 can include additional steps, change the order of steps, and remove steps from that described and illustrated to suit the particular application and performance specifications.

While the disclosure has been described in connection with certain embodiments, it is to be understood that what is taught herein is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A handling system, the system comprising:
an automated bag unloading cell;
a container roller deck positioned in the automated unloading cell, the roller deck comprising:
a deck base;
a deck frame operable to selectively support and transfer a container housing a bag or parcel, the deck frame selectively rotatable about a deck frame axis of rotation relative to the roller deck base, the deck frame operable to selectively release the bag or parcel from the container;
an index table in communication with the deck frame, the index table operable to receive the bag or parcel released from the container, the index table including at least one index table conveyor operable to selectively advance the bag or parcel from the index table to a first transfer device.

2. The system of claim 1, wherein the index table is rotatably connected to the deck frame, the index table independently rotatable relative to the deck frame about an index table axis of rotation.

3. The system of claim 2, wherein the index table includes a plurality of index table conveyors, each of the plurality of index table conveyors independently advances relative to each of the other plurality of index table conveyors.

4. The system of claim 3, wherein the plurality of index conveyors comprises at least a first and a second row of conveyors, each of the first and the second row of conveyors further comprising a front conveyor and a rear conveyor, the front conveyor positioned adjacent to the first transfer device and in communication with the rear conveyor.

5. The system of claim 1, wherein the index table comprises a plurality of index table conveyors, each of the plurality of index table conveyors independently advanceable relative to the other.

6. The system of claim 1, wherein the deck frame further comprises a powered roller platform operable to selectively support and transfer the container between the deck frame and a delivery cart.

7. The system of claim 6, wherein the container roller deck further comprises a secondary drive device operable to selectively engage the delivery cart to assist in the transfer of the container between the delivery cart and the deck frame.

8. The system of claim 1, wherein the first transfer device further comprises a transfer belt conveyor in communication with the automated bag unloading, the transfer belt conveyor having a first rate of advancement.

9. The system of claim 8 further comprising:
a singulation belt conveyor in communication with the transfer belt conveyor, the singulation belt conveyor having a second selectively variable rate of advancement relative to the first rate of advancement of the transfer belt conveyor, and operable to establish a desired distance between the plurality of bags traveling along the transfer belt conveyor.

10. The system of claim 8 further comprising, a scanning system in communication with the transfer belt conveyor operable to selectively scan predetermined metrics of each of the plurality of bags traveling on the transfer belt conveyor.

11. The system of claim 1 further comprising, a manual bag unloading cell in communication with a second transfer device, the second transfer device in communication with the first transfer device.

12. An automated container roller deck for use in unloading bags or parcels from a container to a first transfer device, the container roller deck comprising:
a base positioned in an automated unloading cell;
a deck frame operable to selectively support and transfer a container housing a bag or parcel, the deck frame selectively rotatable about a deck frame axis of rotation relative to the base, the deck frame operable to selectively release the bag or parcel from the container;
an index table in communication with the deck frame, the index table operable to receive the bag or parcel released from the container, the index table including at least one index table conveyor operable to selectively advance the bag or parcel from the index table to a first transfer device.

13. A method for unloading bags or parcels from a vehicle, the method comprising the steps of:
transferring a container housing a bag or parcel from a mobile platform to a container roller deck positioned in an automated unloading cell, the container roller deck having a deck frame operable to support the container and rotatable relative to a container roller deck base;
rotating the deck frame from a first position to a second position relative to the container roller deck base about an deck frame axis of rotation;
depositing the bag or parcel onto an index table; and
selectively transferring the bag or parcel from the index table to a first transfer device.

14. The method of claim 13, wherein the index table is connected to and rotatable relative to the deck frame, the method further comprises:
rotating the deck frame from the second position to the first position, the index table remaining in a substantially horizontal position as the deck frame rotates relative to the index table to the first position.

15. The method of claim 13, wherein the index table further comprises at least a first index table conveyor that advances independently of a second index table conveyor, and selectively transferring the bag or parcel from the index table to the first transfer device further comprises:
selectively advancing one of the first or the second index table conveyors to move the bag or parcel positioned on the first index table conveyor to establish a desired distance between the bag or parcel from another bag or parcel as the bag or parcel and the other bag or parcel travel along the first transfer device.

16. The method of claim 13, wherein the first transfer device further comprises a singulation conveyor, the method further comprising:
separating each of the bags or parcels positioned on the first transfer device by a desired distance using the singulation conveyor.

17. A non-transitory computer-readable medium storing computer-executable instructions therein, which when executed by at least one processor, cause the at least one processor to perform the operations of:
transferring a container housing a bag or parcel from a delivery cart to a container roller deck positioned in an automated unloading cell, the container roller deck having a deck frame operable to support the container and rotatable relative to a container roller deck base;
rotating the deck frame from a first position to a second position relative to the container roller deck base about an deck frame axis of rotation;
depositing the bag or parcel onto an index table; and
selectively transferring the bag or parcel from the index table to a first transfer device.

18. The non-transitory computer-readable medium 17, wherein the at least one processor is further programmed to perform the operations of:
rotating the deck frame from the second position to the first position, the index table remaining in a substantially horizontal position as the deck frame rotates relative to the index table to the first position, and wherein the index table is connected to and rotatable relative to the deck frame.

19. The non-transitory computer-readable medium of claim 17, wherein the index table further comprises a first index table conveyor that advances independently of a second index table conveyor, and selectively transferring the bag or parcel from the index table to the first transfer device, and the at least one processor is further programmed to perform the operations of:
selectively advancing one of the first or the second index table conveyors to move the bag or parcel positioned on the first index table conveyor to establish a desired distance between the bag or parcel from another bag or parcel as the bags or parcels travel along the first transfer device.

20. The non-transitory computer-readable medium of claim 17, wherein the first transfer device further comprises a singulation conveyor, and the at least one processor is further programmed to perform the operations of:
separating each of a plurality of bags positioned on the first transfer device by a desired distance using the singulation conveyor.
